(19) United States
(12) Patent Application Publication
(10) Pub. No.: US 2011/0021676 A1
(43) Pub. Date: Jan. 27, 2011

(54) Method for the Production of a Flame-retardant, Non-corrosive, and Easily flowable Polyamide and Polyester Molding Compounds

(75) Inventors: Sebastian Hoerold, Diedorf (DE); Ottmar Schacker, Gersthofen (DE); Harald Bauer, Kerpen (DE); Werner Krause, Huerth (DE); Daniela Eisenhauer, Koeln (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Finance (BVI) Limited, Tortola (VG)

(21) Appl. No.: 12/919,792

(22) PCT Filed: Feb. 25, 2009
(86) PCT No.: PCT/EP2009/001319

§ 371 Date: Aug. 27, 2010

(30) Foreign Application Priority Data
Mar. 3, 2008 (DE) 10 2008 012 225.4
May 23, 2008 (DE) 10 2008 024 752.9
Aug. 26, 2008 (DE) 10 2008 039 659.1

(51) Int. Cl. C08K 5/3492; C08K 5/5313; C09K 21/12

(52) U.S. Cl. 524/101; 524/133; 524/100; 252/602

(57) ABSTRACT

The invention relates to a process for producing flame-retardant, non-corrosive, highly flawable polyamides and polyesters, which comprises using a flame retardant mixture made of a phosphinic salt of the formula (I), where M═Al, Mg, Ca, Ti, or Na (component A)

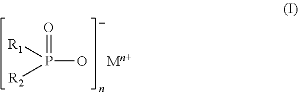

in which
R¹ and R² are identical or different and are C₁-C₆-alkyl, linear or branched, and/or aryl;
n is from 1 to 3,
and, as component B, a metal salt of an organic acid, and/or an inorganic zinc, calcium, magnesium, potassium, sodium, aluminum, titanium, tin, antimony, bismuth, or barium compound, where the amount of component A present in the flame retardant mixture is from 70 to 99.5% by weight and the amount of component B present in the flame retardant mixture is from 0.5 to 30% by weight.

The present invention relates to a process for producing flame-retardant, non-corrosive, and highly flowable molding compositions composed of polyamide or of polyester, and also to said compositions themselves.

Salts of phosphinic acids (phosphinates) have proven to be effective flame-retardant additions for thermoplastic polymers (DE-A-2 252 258 and DE-A-2 447 727). Calcium phosphinates and aluminum phosphinates have been described as particularly effective in polyesters, and cause less impairment of the properties of the polymer molding composition materials than, for example, the alkali metal salts (EP-A-0 699 708).

DE-A-196 07 635 describes calcium phosphinates and aluminum phosphinates as particularly effective flame retardants for polyamides. Polyamides are polymers which have, in the polymer chain, units that repeat by way of an amide group. Particularly suitable polyamides mentioned are nylon-6 and nylon-6,6. Molding compositions produced therefrom achieve UL 94 fire classification V-0 for test specimen thickness of 1.2 mm.

Synergistic combinations of phosphinates with various nitrogen-containing compounds have also been found, and these are more effective as flame retardants than the phosphinates alone in very many polymers (WO 1997/039053, DE-A-197 34 437, DE-A-197 37 727, and U.S. Pat. No. 6,255,371B1).

Compounds described as effective synergists are inter alia melamine and melamine compounds, examples being melamine cyanurate and melamine phosphate, which themselves also have a certain degree of flame-retardant effect in certain thermoplastics, but are markedly more effective in combination with phosphinates.

Higher-molecular-weight derivatives of melamine, such as the condensates melam, melem, and melon, and also appropriate reaction products of said compounds with phosphoric acid, e.g. dimelamine pyrophosphate and melamine polyphosphates, have also been described as flame retardants and as having synergistic action with phosphinates.

DE-A-103 16 873 describes flame-retardant polyamide molding compositions composed of from 30 to 80% by weight of a semiaromatic, semicrystalline polyamide and, as flame retardant, from 1 to 30% by weight of a phosphinic or diphosphinic salt. The effectiveness described for the phosphinic salts is better in semiaromatic polyamides than in aliphatic polyamides.

A disadvantage when the flame retardants described are added is that when compounded materials comprising high-temperature polyamide or polyester are compounded or injection-molded with certain phosphinates there is increased wear of metal parts of the plastifying unit and of the die.

When hard fillers (e.g. glass fibers) are combined with corrosive cleavage products (for example from flame retardants) they generally lead to wear of metallic surfaces of tooling. As a function of the quality of the material of the metallic surfaces, and of the plastics used, this necessitates increased frequency of replacement of heating jackets in the conveying unit, and of the conveying screw, and also of the injection molds. Glassfiber-reinforced thermoplastic polymers are abrasive, and this restricts the possibilities for protecting the screws from corrosion, because steels that have high corrosion resistance do not have the hardness required for processing glassfiber-reinforced polymers.

According to DIN EN ISO 8044, corrosion is the physicochemical interaction between a metal and its environment, where a possible result is alteration of the properties of the metal and thus substantial impairment of the function of the metal, of the environment, or of the technical system of which the metal forms a part.

Miniaturization, particularly in the electronics industry, requires production of very thin-walled components, and the molding compositions used for this purpose therefore require UL 94 V-0 fire classification at 0.4 mm. It is moreover important that the polyamides used in thin-walled applications have high flowability.

Another disadvantage when the flame retardants described are added is that the content of infusible solids reduces flowability when comparison is made with the non-flame-retardant polyamide.

It was therefore an object of the present invention to provide a process for producing flame-retardant polyamides and polyesters which use a halogen-free flame retardant system to achieve UL 94 V-0 at 0.4 mm wall thickness, and which achieve values similar to those of non-flame-retardant polymers in respect of wear on materials, and which have high flowability and resistance to migration.

Surprisingly, it has now been found that mixtures made of phosphinates of the metals Al, Mg, Ca, Ti, Zn, or Na with certain metal soaps and metal salts are effective flame retardants in polyesters and polyamides, inclusive of semiaromatic high-temperature polyamides, and moreover can achieve a markedly lower level of wear on materials and higher levels of flowability than the phosphinates of the metals when these are used alone. Surprisingly, it has also been found that the high heat resistance of the polymers, in particular of the polyamides, is substantially retained after addition of the phosphinates of the abovementioned metals, with metal soaps and metal salts, and that the phosphinates/polymer mixtures can be processed at high temperatures without polymer degradation or discoloration.

The dimensional stability of these polymers at high temperatures, and the advantageous fire performance, make these polymers, in particular the high-temperature polyamides, highly suitable for producing thin-walled moldings for the electrical and electronics industry.

The invention therefore provides a process for producing flame-retardant, non-corrosive, highly flowable polyamides and polyesters, which comprises using a flame retardant mixture made of a phosphinic salt of the formula (I), where M═Al, Mg, Ca, Ti, Zn, or Na (component A)

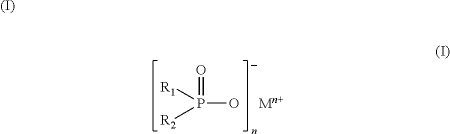

in which

R¹ and R² are identical or different and are C₁-C₆-alkyl, linear or branched, and/or aryl;

n is from 1 to 3;

and, as component B, a metal salt of an organic acid, and/or an inorganic zinc, calcium, magnesium, potassium, sodium, aluminum, titanium, tin, antimony, bismuth, or barium compound, where the amount of component A present in the flame retardant mixture is from 70 to 99.5% by weight and the amount of component B present in the flame retardant mixture is from 0.5 to 30% by weight.

Preferred amounts present are from 95 to 99.5% by weight of component A and from 0.5 to 5% by weight of component B.

The metal salts of the organic acids are preferably the aluminum, magnesium, potassium, sodium, calcium, zinc, or barium salts of long-chain aliphatic carboxylic acids (fatty acids), which typically have chain lengths of from C₁₄ to C₄₀.

It is preferable that component B is salts of stearic acid, e.g. sodium stearate, calcium stearate, barium stearate, aluminum stearate, and/or zinc stearate.

It is particularly preferable that component B is reaction products of montan wax acids with a calcium or sodium salt.

It is preferable that the inorganic zinc, calcium, magnesium, potassium, sodium, aluminum, titanium, tin, antimony, bismuth, or barium compounds are oxides, hydroxides, oxide hydroxides, carbonates, hydroxycarbonates, borates, silicates, nitrates, nitrites, sulfates, sulfites, phosphates, phosphites, phosphinates, stannates and/or aluminates.

It is preferable that component B is inorganic zinc, calcium, magnesium, sodium, and/or barium compounds; the sodium compounds are sodium phosphite, sodium hypophosphite, and/or—in the event that M≠Na—the sodium salt of dimethylphosphinic acid, of diethylphosphinic acid, and/or of ethylmethylphosphinic acid; sodium nitrate and/or sodium nitrite; the barium compounds are barium sulfate; the calcium compounds are calcium carbonate, calcium phosphite, and/or calcium hypophosphite, the magnesium compounds are magnesium borate, magnesium hydroxide, hydrotalcites, magnesium carbonates, or magnesium calcium carbonates; the zinc compounds are zinc oxide, zinc carbonate, zinc hydroxycarbonate, zinc stannate, zinc hydroxystannate, zinc phosphate, zinc borate, and/or zinc sulfides, and/or—in the event that M≠Zn—the zinc salt of dimethylphosphinic acid, of diethylphosphinic acid, and/or of ethylmethylphosphinic acid; the aluminum compounds are aluminum oxide, aluminum hydroxide, and/or aluminum phosphate, aluminum hypophosphite, aluminum nitrate, basic aluminum nitrate, and/or boehmite.

It is particularly preferable that component B is sodium phosphite, barium sulfate, zinc carbonate, zinc stannate, and/or—in the event that M≠Zn—the zinc salt of diethylphosphinic acid.

It is preferable that R¹ and R², being identical or different, are methyl, ethyl, n-propyl, isopropyl, n-butyl, tert-butyl, n-pentyl and/or phenyl.

It is preferable that the polyamides are aliphatic or semiaromatic polyamides.

It is preferable that the polyamides contain, as aromatic diamines, phenylenediamines or xylylenediamines.

It is preferable that the polyamides contain, as aromatic dicarboxylic acids, terephthalic acid or isophthalic acid.

It is preferable that the process of the invention introduces, as further component C, a nitrogen, phosphorus, or phosphorus-nitrogen compound.

It is preferable that component C is melamine phosphate, dimelamine phosphate, melamine pyrophosphate, melamine polyphosphates, melam polyphosphates, melem polyphosphates, and/or melon polyphosphates, and/or melamine condensates, such as melam, melem, and/or melon.

It is also preferable that component C is oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, dicyandiamide, guanidine, and/or carbodiimides.

It is preferable that the polyesters are polyethylene terephthalate or polybutylene terephthalate.

The invention also provides a process for producing flame-retardant, non-corrosive, highly flowable polyamides and polyesters and also molding compositions therefrom, wherein the flame-retardant components A and B, and also, if appropriate, C are incorporated into the polyamides by premixing all of the constituents in the form of powders and/or pellets in a mixer and then homogenizing the same in the polymer melt in a compounding assembly, and then drawing off the resultant melt in the form of a strand, and cooling and pelletizing the same.

The invention also provides a process for producing flame-retardant, non-corrosive, highly flowable polyamides and polyesters and also molding compositions therefrom, wherein the flame-retardant components A and B, and also, if appropriate, C are incorporated into the polyamides by introducing all of the constituents directly in the form of powders and/or pellets respectively separately by way of a metering system into the compounding assembly.

The invention also provides a process for producing flame-retardant, non-corrosive, highly flowable polyamides and polyesters and also molding compositions therefrom, wherein the flame-retardant components A and B, and also, if appropriate, C are incorporated into the polyamides by admixing all of the constituents with finished polymer pellets or with finished polymer powder, and processing the mixture directly in an injection-molding machine to give moldings.

It is preferable that the polymers comprise from 5 to 60% by weight of fibrous or particulate fillers, or a mixture of these.

Finally, the invention also provides the use of flame retardant mixtures made of at least one phosphinic salt of the formula (I), where M═Al, Mg, Ca, Ti, Zn, or Na (component A)

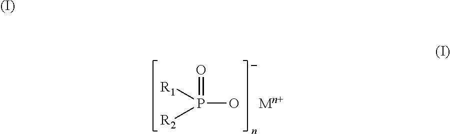

in which

R¹ and R² are identical or different and are C₁-C₆-alkyl, linear or branched, and/or aryl;

n is from 1 to 3;

and of at least one component B, which is a metal salt of an organic acid, and/or an inorganic zinc, calcium, magnesium, potassium, sodium, aluminum, titanium, tin, antimony, bismuth, or barium compound, where the amount of component A present in the flame retardant mixture is from 70 to 99.5% by weight and the amount of component B present in the flame retardant mixture is from 0.5 to 30% by weight, for inhibiting corrosion in the production of polyamides and polyesters.

It is preferable that the polyamides and polyesters here are highly flowable.

It is preferable that the use of the invention inhibits the corrosion of metal parts of the plastifying unit and/or of the die during the compounding or injection-molding of polyester and/or polyamides, and/or of materials compounded therefrom.

The invention also provides non-corrosive molding compositions composed of polyamide or of polyester and comprising from 0.05 to 30% by weight of a flame retardant mixture made of a phosphinic salt of the formula (I), where M═Al, Mg, Ca, Ti, Zn, or Na (component A)

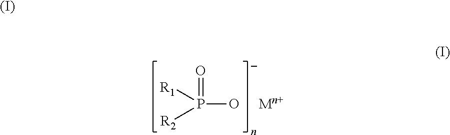

in which

R¹ and R² are identical or different and are C₁-C₆-alkyl, linear or branched, and/or aryl;

n is from 1 to 3;

and, as component B, a metal salt of an organic acid, and/or an inorganic zinc, calcium, magnesium, potassium, sodium, aluminum, titanium, tin, antimony, bismuth, or barium compound, where the amount of component A present in the flame retardant mixture is from 70 to 99.5% by weight and the amount of component B present in the flame retardant mixture is from 0.5 to 30% by weight, with from 99.95 to 70% by weight of polyamide and/or polyester.

The resultant polyamides and polyesters have a high level of migration resistance.

It is preferable that the metal salts of the organic acids are the aluminum, magnesium, sodium, calcium, zinc, or barium salts of octadecanoic acid, stearic acid, (═C₁₈), nonadecanoic acid (═C₁₉), eicosanoic acid, arachic acid, arachidic acid, icosanoic acid (═C₂₀); docosanoic acid, behenic acid, (═C₂₂), and montanic acid.

Examples of other suitable anticorrosion agents are benzotriazoles, (amino)phosphonate, siloxane, benzoate, and sebacate.

In the case of polyamides, it is preferable that the polymers are of amino-acid type and/or of diamine-dicarboxylic-acid type.

It is preferable that the polyamides are nylon-6, nylon-12, semiaromatic polyamides, and/or nylon-6,6. Preference is given here to semicrystalline polyamides.

Suitable semiaromatic, semicrystalline polyamides used in the invention can be either homopolyamides or copolyamides, where the repeat units of these derive from dicarboxylic acids and diamines, or else from aminocarboxylic acids or the corresponding lactams. Suitable dicarboxylic acids are aromatic and aliphatic dicarboxylic acids such as terephthalic acid, isophthalic acid, adipic acid, azelaic acid, sebacic acid, dodecanedicarboxylic acid, and 1,4-cyclohexanedicarboxylic acid. Suitable diamines are aliphatic and cycloaliphatic diamines such as hexamethylenediamine, nonamethylenediamine, decamethylenediamine, dodecamethylenediamine, 2-methylpentamethylenediamine, 1,4-cyclohexane-diamine, di(4-diaminocyclohexyl)methane, di(3-methyl-4-aminocyclohexyl)-methane. Suitable aminocarboxylic acids are aminocaproic acid and aminolauric acid, and these can also be used in the form of the corresponding lactams caprolactam and laurolactam.

The melting points of these semiaromatic polyamides are from 280 to 340° C., preferably from 295 to 325° C.

Among the polyamides, particular preference is given to those formed from terephthalic acid (TPA), isophthalic acid (IPA), and hexamethylenediamine, or, respectively, from terephthalic acid, adipic acid, and hexamethylenediamine. Advantageous ratios here have been found to be about 70:30 TPA:IPA or 55:45 TPA:adipic acid. These two specific polyamides in particular achieve the superior properties.

The polyesters are those selected from the group of the polyalkylene terephthalates. Polyalkylene terephthalates for the purposes of the invention are reaction products of aromatic dicarboxylic acids or of their reactive derivatives (e.g. dimethyl esters or anhydrides) and of aliphatic, cycloaliphatic, or araliphatic diols, and mixtures of said reaction products.

Polyalkylene terephthalates to be used with preference in the invention can be produced by known methods from terephthalic acid (or from its reactive derivatives) and from aliphatic or cycloaliphatic diols having from 2 to 10 carbon atoms (Kunststoff-Handbuch [Plastics handbook], volume VIII, pp. 695 ff., Karl-Hanser-Verlag, Munich, 1973).

It is particularly preferable that the material is polyethylene terephthalate or polybutylene terephthalate, or a mixture of the two polyesters.

Melamine polyphosphate, melem, or melamine cyanurate is particularly preferred as component C.

Copolyamides are products produced from more than one polyamide-forming monomer. The properties of the polyamides can be varied very widely via the selection of the monomers and of the mixing ratio. Certain copolyamides using aromatic monomers are products of greater industrial interest than the aliphatic copolyamides. They feature a higher glass transition temperature and a higher melting point of the semicrystalline domains, and therefore have adequate heat resistance for practical use. By way of example, semicrystalline polyamides with high heat resistance can be produced from terephthalic acid and/or isophthalic acid and from polyamines such as hexamethylenediamine.

Semiaromatic copolyamides suitable in the invention are described by way of example in Becker/Braun Kunststoff Handbuch [Plastics handbook] ¾, Polyamide [Polyamides], edited by L. Bottenbruch and R. Binsack, chapter 6, Teilaromatische und aromatische Polyamide [Semiaromatic and aromatic polyamides], pp. 803-845, which is expressly incorporated herein by way of reference.

Semiaromatic copolyamides suitable in the invention can also be block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides can also be used; as also can polyamides condensed during processing (“IM polyamide systems”).

In the invention, particular preference is given to polyalkylene terephthalates which are produced solely from terephthalic acid and from its reactive derivatives (e.g. dialkyl esters thereof), and ethylene glycol and/or 1,3-propanediol, and/or 1,4-butanediol (polyethylene, polytrimethylene, and polybutylene terephthalate), and to mixtures of said polyalkylene terephthalates.

The term “phosphinic salt” hereinafter encompasses salts of phosphinic and of diphosphinic acids, and polymers of these.

The phosphinic salts, produced in an aqueous medium, are in essence monomeric compounds. Polymeric phosphinic salts can also sometimes be produced, as a function of the reaction conditions.

Examples of suitable phosphinic acids as constituent of the phosphinic salts are: dimethylphosphinic acid, ethylmethylphosphinic acid, diethyiphosphinic acid, methyl-n-propylphosphinic acid, dipropylphosphinic acid, ethylbutylphosphinic acid, dibutylphosphinic acid, ethylhexylphosphinic acid, butylhexylphosphinic acid, methylphenylphosphinic acid, and diphenylphosphinic acid.

The salts of the phosphinic acids for the present invention can be produced by known methods, as described by way of example in more detail in EP-A-0 699 708. By way of example, the phosphinic acids here are reacted in aqueous solution with metal carbonates, metal hydroxides, or metal oxides.

The abovementioned phosphinic salts can be used in various physical forms for the flame retardant combination of the invention, as a function of the nature of the polymer used and of the properties desired. By way of example, the phosphinic salts can be milled to give a fine-particle form in order to achieve better dispersion in the polymer. The phosphinic salts used in the flame retardant combination in the invention are thermally stable, and do not decompose the polymers during processing, and do not affect the process for producing the plastics molding composition. The phosphinic salts are not volatile under the usual conditions for producing and processing thermoplastic polymers.

The flame-retardant components A and B, and also, if appropriate, C can be incorporated into the polyamides by, for instance, premixing all of the constituents in the form of powders and/or pellets in a mixer and then homogenizing the same in the polymer melt in a compounding assembly (e.g. a twin-screw extruder). The melt is usually drawn off in the form of a strand, cooled and pelletized. Components A and B, and also, if appropriate, C can also be introduced directly separately by way of a metering system into the compounding assembly.

It is equally possible to admix the flame-retardant components A and B, and also, if appropriate, C with finished polymer pellets or with finished polymer powder, and to process the mixture directly in an injection-molding machine to give moldings.

The polymers of the invention can comprise from 5 to 60% by weight of fibrous or particulate fillers, or a mixture of these, as further components. Examples that may be mentioned of fibrous fillers are fibrous reinforcing agents such as glass fibers, carbon fibers, aramid fibers, and potassium titanium whiskers, preference being given here to glass fibers. The form in which the glass fibers are incorporated into the molding compositions can either be that of continuous-filament strands (rovings) or cut form (short glass fibers). The glass fibers used can have been equipped with a size and with a coupling agent, in order to improve compatibility with the semiaromatic polyamides. The diameter of the glass fiber usually used is in the range from 6 to 20 μm.

Suitable particulate fillers are inter alia glass beads, chalk, powdered quartz, talc, wollastonite, kaolin, mica. Examples of conventional additives are heat stabilizers, antioxidants, light stabilizers, lubricants, mold-release agents, nucleating agents, pigments, dyes, antidrip agents.

The flame-retardant, non-corrosive polyamides and polyesters of the invention are suitable for producing moldings, films, filaments, and fibers, for example via injection molding, extrusion, or pressing.

There are product safety specifications and standards that set out the fire-protection measures relating to electrical and electronic equipment. In the USA, testing and approval procedures relating to fire protection are the responsibility of Underwriters Laboratories (UL). The UL specifications are nowadays accepted worldwide. The fire tests for plastics were developed in order to determine the resistance of the materials to ignition and flame spread.

As a function of fire protection requirements, the materials have to pass horizontal burning tests (classification to UL 94 HB) or the more stringent vertical tests (UL 94 V-2, V-1, or V-0). These tests simulate low-energy sources of ignition which occur in electrical devices and to which plastics parts within electrical modules can be exposed.

### EXAMPLES

### 1. Components Used

Commercially available polymers (pellets):

Nylon-6,6: Ultramid® A 3 (BASF AG, D) PBT: Ultradur 4500 (BASF, D)

Semiaromatic polyamides:

Nylon-6,T/6,6: Zytel® HTN FE 8200 (DuPont, USA): Polyamide made of terephthalic acid, diaminohexane, and 2-methyldiaminopentane

Glass fibers: Vetrotex EC 10 983, Vetrotex, France, for polyamides Glass fibers: Vetrotex EC 10 952, Vetrotex, France, for PBT

Flame retardant components (pulverulent):

Aluminum diethylphosphinate, hereinafter termed DEPAL

Zinc diethylphosphinate, hereinafter termed DEPZN, melting point 200° C. Boehmite: Apyral® AOH 60, Nabaltec, D Brüggolen H10 sodium phosphite, Brüggemann, D Sodium hypophosphite, Vopelius, D Flametard S zinc stannate, William Blythe, GB Zinc borate: Firebrake® 500, Borax, USA AC zinc carbonate, Brüggemann, D

Melamine polyphosphate, hereinafter termed MPP, Melapur® 200, Ciba SC, Switzerland

Melamine cyanurate, hereinafter termed MC, Melapur® MC 50, Ciba SC, Switzerland

Salts of organic acids: Calcium stearate, sodium stearate, magnesium stearate, zinc stearate, barium stearate, aluminum stearate, Peter Greven Fettchemie, D

Licomont CaV102 calcium montanate Licomont NaV101 sodium montanate Clariant Produkte (Germany) GmbH, D

### 2. Production, Processing, and Testing of Flame-Retardant Plastics Molding Compositions

The polymers were processed in a twin-screw extruder (Leistritz ZSE 25/44) at temperatures of from 250 to 275° C. (GRPBT), from 260 to 280° C. (GRPA 6.6) and, respectively, from 300 to 320° C. (semiaromatic polyamides). The homogenized polymer strand was drawn off, cooled in a water bath, and then pelletized. The flame retardant components were mixed in the ratio stated in the tables, and added by way of a side feed to the polymer melt. The glass fibers were likewise added by way of a side feed.

After adequate drying, the molding compositions were processed in an injection-molding machine (Arburg 320 C Allrounder) to give test specimens, and tested and classified for flame retardancy on the basis of the UL 94 test (Underwriters Laboratories) and the glow-wire test to IEC 60695-2. The flowability of the molding compositions was determined by injection into flow spirals. The length of the flow path is a measure of flowability under injection-molding conditions.

Corrosion was studied by the lamina method. The lamina method, developed by the DKI (Deutsches Kunststoffinstitut) in Darmstadt, serves for model studies directed at comparative evaluation of metallic materials and, respectively, the extent to which molding compositions cause corrosion and wear during their plastification. In this test, two test specimens are arranged in the form of a pair in the die in such a way that they form a rectangular gap of length 12 mm, width 10 mm, and adjustable height from 0.1 to at most 1 mm, for passage of the plastics melt. Plastics melt from a plastifying assembly is extruded (or injected) through this gap, producing large local shear stresses and shear rates within the gap (Günther Mennig, Markus Lake “Verschleiβminderung in der Kunststoffverarbeitung—Phänomene und Schutzmaβnahmen” [Wear reduction in plastics processing—phenomena and preventive measures], 2^{nd} edition Carl Hanser Verlag, Munich, 2008, pages 281-284; Eggering, P. et. al.: “Verschleiβ an Metalloberflächen, die mit schnell strömenden Kunststoffschmelzen in Berührung stehen” [Wear on metal surfaces in contact with fast-flowing plastics melts] Kunststofftechnik 10 (1971) 5, pages 159-168).

A variable that measures wear is the loss in weight from the test specimens, and this is determined by using an A&D “Electronic Balance” analysis balance, tolerance 0.1 mg, for differential weighing of the test specimens. The mass of the test specimens was determined before and after the corrosion test, using respectively 25 or 50 kg of polymer throughput.

After a predefined throughput (generally 25 or 50 kg), the test laminae are removed and cleaned physically/chemically to remove the adherent plastic. The method of physical cleaning is rubbing with a soft material (cotton) to remove the hot plastics composition. The method of chemical cleaning is heating of the test specimens to 60° C. in m-cresol for 20 minutes. Any adherent plastics composition remaining after this heating process is removed by rubbing with a soft cotton pad.

Unless otherwise stated, all of the tests in each series were carried out under identical conditions (temperature profile, screw geometries, injection-molding parameters, etc) for reasons of comparability. Unless otherwise stated, quantities are always given in % by weight.

Table 1 shows that 15% addition of DEPAL in semiaromatic polyamide achieves V-0, but with significant corrosion, either with or without glassfiber reinforcement. Surprisingly, it has now been found that when DEPZN partially replaced DEPAL the extent of corrosion is significantly lower, with a simultaneous improvement in flowability. Addition of sodium phosphite, zinc stannate, zinc carbonate, sodium montanate or aluminum stearate, or a combination of zinc carbonate and sodium montanate, likewise surprisingly reduces the extent of corrosion.

TABLE 1
DEPAL with additions of the invention (inv.) as flame retardant in
glassfiber-reinforced and unreinforced PA 6T/66 (comp. = comparison)

| | Examples | | | | |
|---|---|---|---|---|---|
| | 1 (comp.) | 2 (comp.) | 3 (inv.) | 4 (inv.) | 5 (inv.) |
| Nylon-6,T/6,6 | 55 | 85 | 55 | 55 | 54.5 |
| Glass fibers | 30 | | 30 | 30 | 30 |
| DEPAL | 15 | 15 | 13 | 10 | 15 |
| DEPZN | | | 2 | 5 | |
| Sodium phosphite | | | | | 0.5 |
| Extent of | significant | significant | significant | low | low |
| corrosion* | | | | | |
| UL 94 0.8 mm | V-0 | V-0 | V-0 | V-0 | V-0 |
| Length of flow | 37 | n.d. | 44 | 48 | 38 |
| path in cm | | | | | |

*Lamina method

| | Examples | | | | |
|---|---|---|---|---|---|
| | 6 (inv.) | 7 (inv.) | 8 (inv.) | 9 (inv.) | 10 (inv.) |
| Nylon-6,T/6,6 | 54.5 | 54.5 | 54.5 | 54.5 | 54.5 |
| Glass fibers | 30 | 30 | 30 | 30 | 30 |
| DEPAL | 15 | 15 | 15 | 15 | 15 |
| Zinc stannate | 0.5 | | | | |
| Zinc carbonate | | 0.5 | | | 0.25 |
| Sodium montanate | | | 0.5 | | 0.25 |
| Aluminum stearate | | | | 0.5 | |
| Extent of corrosion* | low | low | low | low | low |
| UL 94 0.8 mm | V-0 | V-0 | V-0 | V-0 | V-0 |
| Length of flow | 37 | 39 | 44 | 44 | 39 |
| path in cm | | | | | |

*Lamina method

Table 2 shows that boehmite and zinc borate have a synergistic effect in relation to DEPAL, and here again the combination of DEPAL and DEPZN can achieve a reduced level of corrosion together with V-0 classification and improved flowability.

TABLE 2
DEPAL and DEPZN with zinc borate and boehmite as synergist
in glassfiber-reinforced PA 6T/66

| | | | 13 | 14 | 15 |
|---|---|---|---|---|---|
| Examples | 11 (comp.) | 12 (comp.) | (inv.) | (inv.) | (inv.) |
| Nylon-6,T/6,6 | 55 | 55 | 55 | 55 | 55 |
| Glass fibers | 30 | 30 | 30 | 30 | 30 |
| DEPAL | 13 | 13 | 11 | 11 | 10 |
| DEPZN | | | 2 | 2 | 3 |
| Zinc borate | 2 | | 2 | | |
| Boehmite | | 2 | | 2 | 2 |
| Extent of corrosion | significant | significant | low | low | low |
| UL 94 0.8 mm | V-0 | V-0 | V-0 | V-0 | V-0 |
| Length of flow path | 37 | 38 | 44 | 45 | 47 |
| in cm | | | | | |

TABLE 3
DEPAL and DEPZN with melamine cyanurate and with melamine
polyphosphate in glassfiber-reinforced PBT

| | 16 | 17 | 18 | 19 | 20 |
|---|---|---|---|---|---|
| Examples | (comp.) | (comp.) | (comp.) | (inv.) | (comp.) |
| PBT | 57 | 57 | 57 | 55 | 55 |
| Glass fibers | 25 | 25 | 25 | 30 | 30 |
| DEPAL | 12 | 12 | 18 | 8 | |
| DEPZN | | | | 4 | 12 |
| Melamine cyanurate | 6 | | | 6 | |
| Melamine | | 6 | | | 6 |
| polyphosphate | | | | | |
| Extent of corrosion | significant | significant | significant | low | low |
| UL 94 0.8 mm | V-0 | V-0 | V-0 | V-0 | V-1 |
| Length of flow path | 37 | 35 | 36 | 47 | 50 |
| in cm | | | | | |

Table 3 shows that although V-0 is achieved with DEPAL in GRPBT, flowability is poor and corrosion is observed. The combination of the invention, using DEPAL with DEPZN, achieves a reduced extent of corrosion, and also improved flowability together with V-0 classification. DEPZN alone does not achieve V-0.

TABLE 4
DEPAL with additions (inv.) of the invention as flame retardant
in glassfiber-reinforced and unreinforced PBT

| | | | 23 | 24 | 25 |
|---|---|---|---|---|---|
| Examples | 21 (inv.) | 22 (inv.) | (inv.) | (inv.) | (inv.) |
| PBT | 56.5 | 56.5 | 56.5 | 81.5 | 56.5 |
| Glass fibers | 25 | 25 | 25 | | 25 |
| DEPAL | 18 | 12 | 12 | 18 | 12 |
| Melamine cyanurate | | 6 | 6 | | 6 |
| Aluminum stearate | 0.5 | | | | |
| Sodium montanate | | 0.5 | | | 0.25 |
| Sodium phosphite | | | 0.5 | | 0.25 |
| Barium sulfate | | | | 0.5 | |
| Extent of corrosion | low | low | low | low | low |
| UL 94 0.8 mm | V-0 | V-0 | V-0 | V-0 | V-0 |
| Length of flow path in cm | 40 | 42 | 37 | n.d. | 50 |

Table 4 shows that the combination of the invention, using DEPAL and, respectively, DEPAL and melamine cyanurate (component C) with aluminum stearate, sodium montanate, sodium phosphite, or barium sulfate (component B), improves flowability, and retains UL 94 V-0 classification, while, surprisingly, the extent of corrosion is low.

Other materials used:

Hydrotalcites: DHT-4A-2, Mitsui Chemicals, Japan Sorbacid 911, Südchemie, D Puralox MG63 HT, Sasol, D Alcamizer P, Kisuma Chemicals, NL

Sodium carbonate, Sigma-Aldrich, D

Storflam ZPB zinc borophosphate, Joseph Storey, UK

TABLE 5
DEPAL with additions (inv.) of the invention as flame retardant in
glassfiber-reinforced PA 6T/66 (comp. = comparison)

| | Examples | | | | |
|---|---|---|---|---|---|
| | | | 27 | 28 | 29 |
| | 25 (inv.) | 26 (inv.) | (inv.) | (inv.) | (comp.) |
| Nylon-6,T/6,6 | 54.5 | 54.5 | 54.5 | 54.5 | 54.5 |
| Glass fibers | 30 | 30 | 30 | 30 | 30 |
| DEPAL | 15 | 15 | 15 | 15 | 15 |
| Hydrotalcite | 0.5 | | | 1.0 | |
| Zinc borophosphate | | 0.5 | | | |
| Sodium carbonate | | | 0.5 | | |
| Extent of corrosion* | low | low | low | zero | significant |
| UL 94 0.8 mm | V-0 | V-0 | V-0 | V-0 | V-0 |

*Lamina method

1. A process for producing flame-retardant, non-corrosive, highly flowable polyamides and polyesters and molding compositions, comprising the step of using a flame retardant mixture made of a phosphinic salt of the formula (I), where M═Al, Mg, Ca, Ti, Zn, or Na (component A) 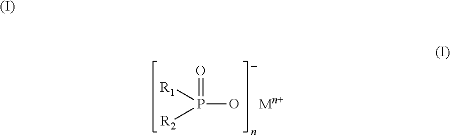
wherein
R¹ and R² are identical or different and are C₁-C₆-alkyl, linear or branched, or aryl;
n is from 1 to 3;
and, as component B, a metal salt of an organic acid, and/or an inorganic zinc, calcium, magnesium, potassium, sodium, aluminum, titanium, tin, antimony, bismuth, or barium compound, or a combination thereof, where the amount of component A present in the flame retardant mixture is from 70 to 99.5% by weight and the amount of component B present in the flame retardant mixture is from 0.5 to 30% by weight.

2. The process as claimed in claim 1, wherein the amount of component A present is from 95 to 99.5% by weight and the amount of component B present is from 0.5 to 5% by weight.

3. The process as claimed in claim 1, wherein the metal salts of organic acids are the aluminum, magnesium, potassium, sodium, calcium, zinc, or barium salts of long-chain aliphatic carboxylic acids (fatty acids), having chain lengths of from C₁₄ to C₄₀.

4. The process as claimed in claim 3, wherein component B is salts of stearic acid.

5. The process as claimed in claim 3, wherein component B is the reaction products of montan wax acids with a calcium or sodium salt.

6. The process as claimed in claim 1, wherein the inorganic zinc, calcium, magnesium, potassium, sodium, aluminum, titanium, tin, antimony, bismuth, or barium compounds are oxides, hydroxides, oxide hydroxides, carbonates, hydroxycarbonates, borates, silicates, nitrates, nitrites, sulfates, sulfites, phosphates, phosphites, phosphinates, stannates, aluminates or a combination thereof.

7. The process as claimed in claim 1, wherein component B is inorganic zinc, calcium, magnesium, sodium, barium compound or a combination; the sodium compounds are sodium phosphite, sodium hypophosphite, and/or—in the event that M≠Na—the sodium salt of dimethylphosphinic acid, of diethylphosphinic acid, and/or of ethylmethylphosphinic acid; sodium nitrate and/or sodium nitrite; the barium compounds are barium sulfate; the calcium compounds are calcium carbonate, calcium phosphite, and/or calcium hypophosphite, the magnesium compounds are magnesium borate, magnesium hydroxide, hydrotalcites, magnesium carbonates, or magnesium calcium carbonates; the zinc compounds are zinc oxide, zinc carbonate, zinc hydroxycarbonate, zinc stannate, zinc hydroxystannate, zinc phosphate, zinc borate, and/or zinc sulfides, and/or—in the event that M≠Zn—the zinc salt of dimethylphosphinic acid, of diethylphosphinic acid, and/or of ethylmethylphosphinic acid; the aluminum compounds are aluminum oxide, aluminum hydroxide, and/or aluminum phosphate, aluminum hypophosphite, aluminum nitrate, basic aluminum nitrate, and/or boehmite.

8. The process as claimed in claim 1, wherein component B is sodium phosphite, barium sulfate, zinc carbonate, zinc stannate, and/or—in the event that M≠Zn—the zinc salt of diethylphosphinic acid.

9. The process as claimed in claim 8, wherein R¹ and R² are identical or different and are methyl, ethyl, n-propyl, isopropyl, n-butyl, tert-butyl, n-pentyl, or phenyl.

10. The process as claimed in claim 1, wherein the polyamides are aliphatic or semiaromatic polyamides.

11. The process as claimed in claim 1, wherein the polyamides contain, as aromatic diamines, phenylenediamines or xylylenediamines.

12. The process as claimed in claim 1, wherein the polyamides contain, as aromatic dicarboxylic acids, terephthalic acid or isophthalic acid.

13. The process as claimed in claim 1 further comprising introducing a component C, wherein compound C is a nitrogen, phosphorus, or phosphorus-nitrogen compound is introduced.

14. The process as claimed in claim 13, wherein component C is melamine phosphate, dimelamine phosphate, melamine pyrophosphate, melamine polyphosphates, melam polyphosphates, melem polyphosphates, melon polyphosphates, melamine condensates or a combination thereof.

15. The process as claimed in claim 13, wherein component C is oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, dicyandiamide, guanidine, carbodiimides or a combination thereof.

16. The process as claimed in claim 1, wherein the polyesters are polyethylene terephthalate or polybutylene terephthalate.

17. The process as claimed in claim 13, further comprising the step of incorporating the flame-retardant components A and B, and also, if appropriate, C into the polyamides by premixing all of the constituents in the form of powders, pellets or a combination thereof in a mixer to form a mixture, homogenizing the mixture in the polymer melt in a compounding assembly, drawing off the resultant melt in the form of a strand, and cooling and pelletizing the resultant melt.

18. The process as claimed in claim 13, further comprising the step of incorporating the flame-retardant components A and B, and also, if appropriate, C into the polyamides by introducing all of the constituents directly in the form of powders, pellets or a combination thereof separately by way of a metering system into a compounding assembly.

19. The process as claimed in claim 13, further comprising the step of incorporating the flame-retardant components A and B, and also, if appropriate, C into the polyamides by admixing all of the constituents with finished polymer pellets or with finished polymer powder to form a mixture, and processing the mixture directly in an injection-molding machine to give moldings.

20. The process as claimed in claim 1, wherein the polymers comprise from 5 to 60% by weight of fibrous or particulate fillers, or a mixture thereof.

21. A corrosion inhibitor in the production of polyamides and polyesters including a flame retardant mixture comprising at least one phosphinic salt of the formula (I), where M═Al, Mg, Ca, Ti, Zn, or Na (component A) 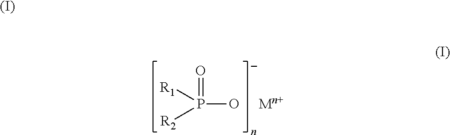
wherein
R¹ and R² are identical or different and are C₁-C₆-alkyl, linear or branched or aryl;
n is from 1 to 3;
and of at least one component B, wherein component B is a metal salt of an organic acid, and/or an inorganic zinc, calcium, magnesium, potassium, sodium, aluminum, titanium, tin, antimony, bismuth, or barium compound or a combination thereof, where the amount of component A present in the flame retardant mixture is from 70 to 99.5% by weight and the amount of component B present in the flame retardant mixture is from 0.5 to 30% by weight.

22. The corrosion inhibitor as claimed in claim 21, wherein the polyamides and polyesters are highly flowable.

23. The corrosion inhibitor as claimed in claim 22, wherein the corrosion of metal parts of the plastifying unit, of the die or both is inhibited during the compounding or injection-molding of polyester, polyamides or of materials compounded therefrom.

24. A non-corrosive molding composition composed of polyamide or of polyester and comprising from 0.05 to 30% by weight of a flame retardant mixture made of a phosphinic salt of the formula (I), where M═Al, Mg, Ca, Ti, Zn, or Na (component A) 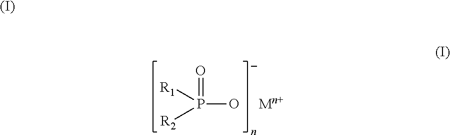
wherein
R¹ and R² are identical or different and are C₁-C₆-alkyl, linear or branched, or aryl;
n is from 1 to 3;
and, as component B, a metal salt of an organic acid, and/or an inorganic zinc, calcium, magnesium, potassium, sodium, aluminum, titanium, tin, antimony, bismuth, or barium compound, or a combination thereof, where the amount of component A present in the flame retardant mixture is from 70 to 99.5% by weight and the amount of component B present in the flame retardant mixture is from 0.5 to 30% by weight, with from 99.95 to 70% by weight of polyamide, polyester or combination thereof.

25. The process as claimed in claim 4, wherein the salts of stearic acid are sodium stearate, calcium stearate, barium stearate, aluminum stearate, zinc stearate or a combination thereof.

26. The process of claim 14, wherein the melam condensates are melam, melem or melon.
